(19) United States
(12) Patent Application Publication
(10) Pub. No.: US 2026/0119791 A1
(43) Pub. Date: Apr. 30, 2026

(54) UTILIZING GENERATIVE MACHINE LEARNING MODELS TO GENERATE CUSTOM DIGITAL DESIGN DOCUMENTS

(71) Applicant: Adobe Inc., San Jose, CA (US)

(72) Inventors: Ashutosh Sharma, Noida (IN); Vishal Garg, Panchkula (IN); Akhil Jindal, Delhi (IN)

(21) Appl. No.: 18/931,640

(22) Filed: Oct. 30, 2024

(51) Int. Cl. G06F 40/186; G06F 40/40

(52) U.S. Cl. CPC G06F 40/186; G06F 40/40

(57) ABSTRACT

The present disclosure relates to systems, non-transitory computer-readable media, and methods for generating digital design documents from client design templates using custom design object locking. Specifically, the disclosed systems receive, from a client device, a selection of a client design template from a client template library and a client text prompt. Additionally, the disclosed systems receive, from the client device, an unlocked design object and a selection of a locked characteristic of a locked design object of the client design template. Moreover, the disclosed systems generate, utilizing a large language model, a modified design object based on the client text prompt and the unlocked design object. Further, the disclosed systems generate, by at least one processing device, the modified digital design document from the client design template by replacing the unlocked design object with the modified design object and retaining the locked characteristic of the locked design object.

### BACKGROUND

Recent years have seen significant improvements in hardware and software platforms for generating and modifying digital design documents. For example, in this technical field, client devices often create design documents based on a variety of user interactions with various user interfaces for selecting and manipulating elements of the digital design document such as text, images, objects. To illustrate, in this field, client devices generate digital fliers, banners, or posters based on client device selection and manipulation of various images, text fields, and/or visual property elements from a variety of user interfaces. In some cases, computing devices repurpose existing system-defined templates and create new digital design documents from the system-defined templates. For example, existing systems access a pre-existing set of system-defined templates and utilize machine learning models to generate modified digital design documents from features of these system-defined templates.

### SUMMARY

Embodiments of the present disclosure provide benefits and/or solve one or more problems in the art with systems, non-transitory computer-readable media, and methods for generating digital design documents from client design templates using custom design object locking. In particular, the disclosed systems use a selection of a client design template from a client template library to generate a modified digital design document. Further, the disclosed systems identify unlocked design objects of the client design template for which to generate modified design objects. Moreover, based on a client text prompt and the unlocked design objects, the disclosed systems use large language models and generative machine learning models to generate modified design objects. Furthermore, the disclosed systems generate the modified digital design document by replacing the unlocked design objects with the modified design objects while retaining locked design objects of the client design template.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a custom design object locking system operates in accordance with one or more embodiments.

FIG. 2 illustrates an overview diagram of the custom design object locking system generating a modified digital design document from a client design template in accordance with one or more embodiments.

FIG. 3 illustrates a diagram of the custom design object locking system receiving a client design template and client text prompt via an example design template generation user interface in accordance with one or more embodiments.

FIG. 4 illustrates a diagram of the custom design object locking system receiving lock selections of design objects of a client design template in accordance with one or more embodiments.

FIG. 5A illustrates a diagram of the custom design object locking system generating a modified digital image for inclusion in a modified digital design document in accordance with one or more embodiments.

FIG. 5B illustrates a diagram of the custom design object locking system generating a modified text object for inclusion in a modified digital design document in accordance with one or more embodiments.

FIG. 6 illustrates a diagram of the custom design object locking system generating and displaying a modified digital design document in accordance with one or more embodiments.

FIG. 7 illustrates an example schematic diagram of the custom design object locking system in accordance with one or more embodiments.

FIG. 8 illustrates an example series of acts for generating a modified digital design document by replacing an unlocked design object of a client design template with a modified design object in accordance with one or more embodiments.

FIG. 9 illustrates an example series of acts 900 for generating a modified digital design document by replacing an unlocked characteristic of a design object in a client design template with a modified characteristic in accordance with one or more embodiments.

FIG. 10 illustrates an example of a guided diffusion model according to aspects of the present disclosure.

FIG. 11 illustrates an example of a U-Net according to aspects of the present disclosure.

FIG. 12 illustrates an example of a method for conditional media generation according to aspects of the present disclosure.

FIG. 13 illustrates a diffusion process according to aspects of the present disclosure.

FIG. 14 illustrates a flow diagram depicting an algorithm as a step-by-step procedure for training a machine-learning model according to aspects of the present disclosure.

FIG. 15 illustrates an example of a method for training a diffusion model according to aspects of the present disclosure.

FIG. 16 illustrates an example of a computing device according to aspects of the present disclosure.

FIG. 17 illustrates an example of a digital image generation apparatus according to aspects of the present disclosure.

### DETAILED DESCRIPTION

This disclosure describes one or more embodiments of a custom design object locking system that generates digital design documents from client design templates using custom design object locking, large language models, and generative machine learning models. The custom design object locking system overcomes technical shortcomings of existing systems, particularly with regard to problems inflexibility of operation, efficiency, and accuracy. For instance, some existing systems demonstrate operational inflexibility by requiring client devices to rigidly manipulate elements of a digital design document. To illustrate, these systems often require client devices to interact with a number of user interfaces and tools to generate, modify, and locate elements within a digital design document. Such existing systems fail to provide functionality of generating digital design elements from minimal user interactions, such as single-click generation of digital design documents.

Some systems exist that utilize computer-implemented models, such as machine learning models, to generate digital design elements for a digital design document. These systems, however, often utilize rigid, system-defined templates and corresponding pre-defined elements to generate digital design documents. Thus, although such systems can generate digital design documents, they lack operational flexibility to adapt those digital design documents to contextualized features or characteristics for individual client device queries. Moreover, such systems rigidly analyze the elements of these templates and fail to provide client devices with individualized flexibility for managing generative processes across different digital design elements.

In addition to operational inflexibility, many existing systems also suffer from significant accuracy and efficiency concerns in generating digital design documents. For instance, conventional systems often fail to generate digital design documents that align to individualized client device queries and corresponding content characteristics. Indeed, even after existing systems generate a digital design document, client devices are often forced to utilize significant time, user interfaces, user interface interactions, and computer resources to modify the digital design document to incorporate contextualized features, such as individualized digital fonts, color palates, images, or other digital design features. Thus, because existing systems utilize pre-defined templates and rigid element modification processes, the resulting digital design elements fail to accurately align to individualized client device needs/queries, resulting in significant inefficiencies in modifying digital design elements to generate digital design documents.

As mentioned above, the custom design object locking system addresses many of the foregoing technical problems by generating digital design documents from client design templates using custom design object locking, large language models, and generative machine learning models. Specifically, in some embodiments, the custom design object locking system determines a selection of a client design template from a client template library from which to generate a modified digital design document. Additionally, the custom design object locking system identifies locked and/or unlocked design objects of the client design template for which to generate modified design objects. Further, based on a client text prompt and the locked/unlocked design objects, the custom design object locking system uses a large language model and a generative machine learning model to generate modified design objects. Moreover, the custom design object locking system generates the modified digital design document by replacing the unlocked design objects with the modified design objects while retaining locked design objects of the client design template.

In some implementations, the custom design object locking system determines a selection of a client design template from a client template library from which to generate a modified digital design document. Specifically, the custom design object locking system determines the selection of the client design template based on user interaction at a client device. In addition, the custom design object locking system identifies a client text prompt via user interaction at the client device. For example, the custom design object locking system identifies a client text prompt which includes a description of a modified digital design document to be generated by the custom design object locking system from the client design template.

As noted above, in one or more embodiments, the custom design object locking system identifies unlocked design objects of the selected client design template for which to generate modified design objects. In particular, the custom design object locking system determines whether design objects of the selected client design template are unlocked or locked (including partially locked). For example, the custom design object locking system receives unlocked design objects and/or unlocked characteristics of locked design objects (e.g., partially locked objects). Furthermore, in one or more implementations, the custom design object locking system generates modified design objects and/or characteristics based on the unlocked design objects and/or characteristics. Conversely, in these or other embodiments, the custom design object locking system does not generate modified design objects or characteristics for locked design objects or locked characteristics of partially locked design objects.

As mentioned previously, in some embodiments, based on a client text prompt and the unlocked design objects, the custom design object locking system uses a large language model and a generative machine learning model to generate modified design objects based on the unlocked design objects. Specifically, the custom design object locking system uses a large language model to generate a prompt summary from the client text prompt to generate modified design objects such as modified text objects and/or modified digital images. For example, the custom design object locking system uses a large language model to generate modified design objects such as text objects (or characteristics thereof) based on the prompt summary and one or more parameters of the original text object of the client design template.

Additionally, in some implementations, the custom design object locking system uses a generative machine learning model to generate modified design objects such as modified digital images (or characteristics thereof) based on the prompt summary and the original digital image of the client design template. For example, the custom design object locking system uses the generative machine learning model to generate a candidate modified digital image for comparison with a candidate modified digital image selected from a digital image repository. In these or other embodiments, the custom design object locking system selects one of these candidate modified digital images to use when generating the modified digital design document.

As noted previously, in one or more embodiments, the custom design object locking system generates the modified digital design using the modified design objects. Specifically, the custom design object locking system replaces the unlocked design objects (or unlocked characteristics of partially locked design objects) with the modified design objects (or modified characteristics). For example, the custom design object locking system replaces original text objects or digital images of the client design template with modified text objects or modified digital images. Further, in one or more implementations, the custom design object locking system retains locked design objects (or locked characteristics of partially locked design objects) in the modified digital design document.

As suggested by the foregoing, the custom design object locking system provides a variety of technical advantages relative to conventional systems. For example, by using custom client design templates and custom locking of design objects, the custom design object locking system improves flexibility relative to conventional systems. Specifically, unlike conventional systems, in some embodiments, the custom design object locking system selects individualized client design templates from a client template library to generate digital design documents using generative AI tools. Thus, the custom design object locking system provides improved flexibility via use of client design templates that include individualized client-device elements (e.g., colors, fonts, logos, etc.).

Moreover, in some implementations, the custom design object locking system improves flexibility via custom locking of design objects of a digital design document. For instance, the custom design object locking system allows for locking or partially locking some design objects of a design template while leaving others unlocked. This functionality allows for the custom design object locking system to automatically generate modified design objects via AI tools to replace unlocked or partially locked design objects of the design template while retaining the locked design objects or locked characteristics of partially locked design objects. Indeed, in embodiments employing this functionality, the custom design object locking system is capable of using AI tools to rapidly generate a modified digital design document by replacing all unlocked objects and/or object characteristics at once.

Moreover, by using on-brand client design templates and custom locking of design objects, the custom design object locking system improves efficiency relative to conventional systems. In particular, the custom design object locking system automatically generates modified digital design documents by replacing unlocked design objects and characteristics while retaining locked design objects and characteristics. For example, in one or more embodiments, the custom design object locking system performs this function automatically in response to a single client text prompt. Thus, the custom design object locking system improves efficiency by significantly reducing the number of user interactions and computing resources required to generate a modified digital design document. Indeed, the custom design object locking system avoids the need to utilize receive multiple user interactions and occupy the computing resources associated therewith to generate modified design objects individually. Furthermore, by using the on-brand client design templates rather than no template at all or only generic templates, the custom design object locking system also reduces receiving user interactions and computing resources needed to generate entirely new digital design documents or modify generic templates.

Additionally, by using client design templates and custom locking of design objects, the custom design object locking system improves accuracy relative to conventional systems. Specifically, by using client design templates from a client template library that are already individualized to the needs/queries of a client device, the custom design object locking system generates modified design objects and characteristics that accurately align to the individualized queries and characteristics of a client device. Moreover, by using the custom design object locking, the custom design object locking system accurately generates modified digital design documents that retain locked design objects while replacing unlocked design objects and characteristics of design objects. For example, the custom design object locking system generates a modified digital design document that retains locked design objects such as a digital image object containing a brand logo or a text object containing a brand name. Additionally, the custom design object locking system accurately generates modified design objects and characteristics thereof by doing so according to locked characteristics (e.g., size, shape, etc.).

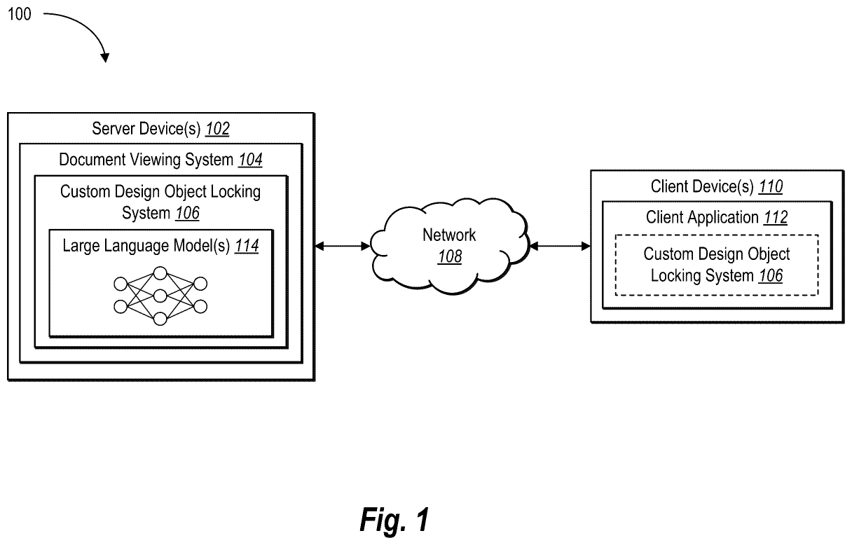

Additional detail regarding the custom design object locking system will now be provided with reference to the figures. For example, FIG. 1 illustrates a schematic diagram of a system environment 100 in which a custom design object locking system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the custom design object locking system 106 via the network 108). Similarly, although FIG. 1 illustrates a particular arrangement of the server device(s) 102, the network 108, and the client device(s) 110, various additional arrangements are possible.

The server device(s) 102, the network 108, and the client device(s) 110 are communicatively coupled with each other either directly or indirectly (e.g., through the network 108). Moreover, the server device(s) 102 and the client device(s) 110 include one or more of a variety of computing devices.

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server or a web-hosting server.

As shown, the server device(s) 102 includes a document viewing system 104. In one or more embodiments, the document viewing system 104 provides functionality by which a client device (e.g., the client device(s) 110) views, generates, stores, and/or edits digital documents, such as digital design documents. For example, in some instances, a client device sends a digital design document to the document viewing system 104 hosted on the server device(s) 102 via the network 108. The document viewing system 104 then provides many options that are usable by the client device to edit the digital design document, store the digital design document, and subsequently search for, access, and view the digital design document. To illustrate, the document viewing system 104 provides one or more options that are usable by the client device to create and edit digital design documents and/or client design templates.

As further shown, the server device(s) 102 also include the custom design object locking system 106 for generating modified digital design documents based on client design templates in the document viewing system 104. In one or more embodiments, the custom design object locking system 106 generates modified design objects based on original design objects of client design templates. In particular, as will be explained below, the custom design object locking system generates modified design objects such as digital images and/or digital images to generate modified digital design documents based on the client design templates.

As illustrated in FIG. 1, the custom design object locking system 106 includes a machine learning model(s) 114. Indeed, in these or other embodiments, the custom design object locking system 106 implements the machine learning model(s) 114 to generate and/or implement modified design objects. In some cases, the machine learning model(s) 114 are external to the custom design object locking system 106, but the custom design object locking system 106 nevertheless accesses and utilizes the machine learning model(s) 114 via one or more plugins, APIs, or other network-based access protocols.

For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

In one or more embodiments, the client device(s) 110 includes a computing device that accesses, edits, segments, modifies, stores, and/or provides, for display, digital content such as digital design documents and/or client design templates. For example, in some embodiments, the client device(s) 110 includes a smartphone, a tablet, a desktop computer, a laptop computer, a head-mounted-display device, or another electronic device. In some instances, the client device(s) 110 includes one or more applications (e.g., a client application 112) that access, edit, segment, modify, store, and/or provide, for display, digital content such as digital design documents. For example, in one or more embodiments, the client application 112 includes a software application installed on the client device(s) 110. Additionally, or alternatively, the client application 112 includes a web browser or other application that accesses a software application hosted on the server device(s) 102 (and supported by the document viewing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicates via the network using one or more communication platforms and technologies suitable for transporting data and/or communication signals, including any known communication technologies, devices, media, and protocols supportive of data communications.

To provide an example implementation, in some embodiments, the custom design object locking system 106 on the server device(s) 102 supports the custom design object locking system 106 on the client device(s) 110. For instance, in some cases, the custom design object locking system 106 on the server device(s) 102 generates or learns parameters for the machine learning model(s) 114. The custom design object locking system 106 then, via the server device(s) 102, provides the machine learning model(s) 114 to the client device(s) 110. In other words, the client device(s) 110 obtains (e.g., downloads) the machine learning model(s) 114 from the server device(s) 102. Once downloaded, the custom design object locking system 106 on the client device(s) 110 uses the machine learning model(s) 114 to generate modified design objects for inclusion in modified digital design documents independent of the server device(s) 102. In some implementations, the custom design object locking system 106 generates or learns parameters for the machine learning model(s) 114 on the client device(s) 110.

In alternative implementations, the custom design object locking system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a client design template including one or more design objects. In response, the custom design object locking system 106 on the server device(s) 102 generates modified digital design documents including modified design objects from the client design template. The server device(s) 102 then provides the modified digital design document with the editable text object to the client device(s) 110 for display.

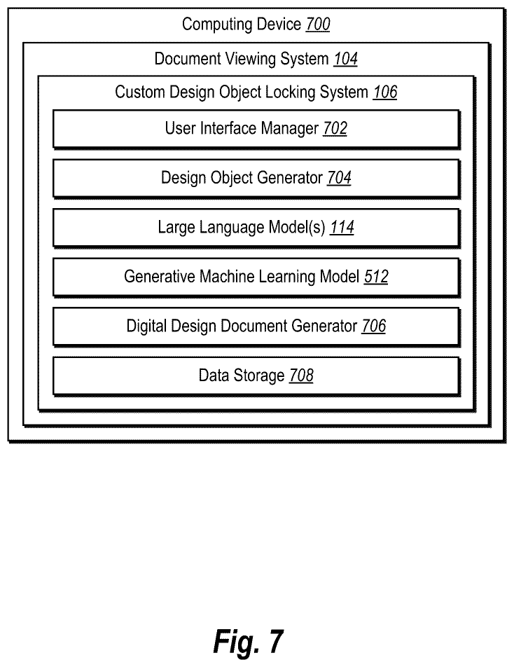

Although FIG. 1 illustrates the custom design object locking system 106 implemented with regard to the server device(s) 102, different components of the custom design object locking system 106 are able to be implemented by a variety of devices within the system environment 100. For example, in some instances, a different computing device (e.g., the client device(s) 110) or a separate server from the server device(s) 102 implements one or more (or all) components of the custom design object locking system 106. Indeed, as shown in FIG. 1, the client device(s) 110 includes the custom design object locking system 106. Example components of the custom design object locking system 106 will be described below with regard to FIG. 7.

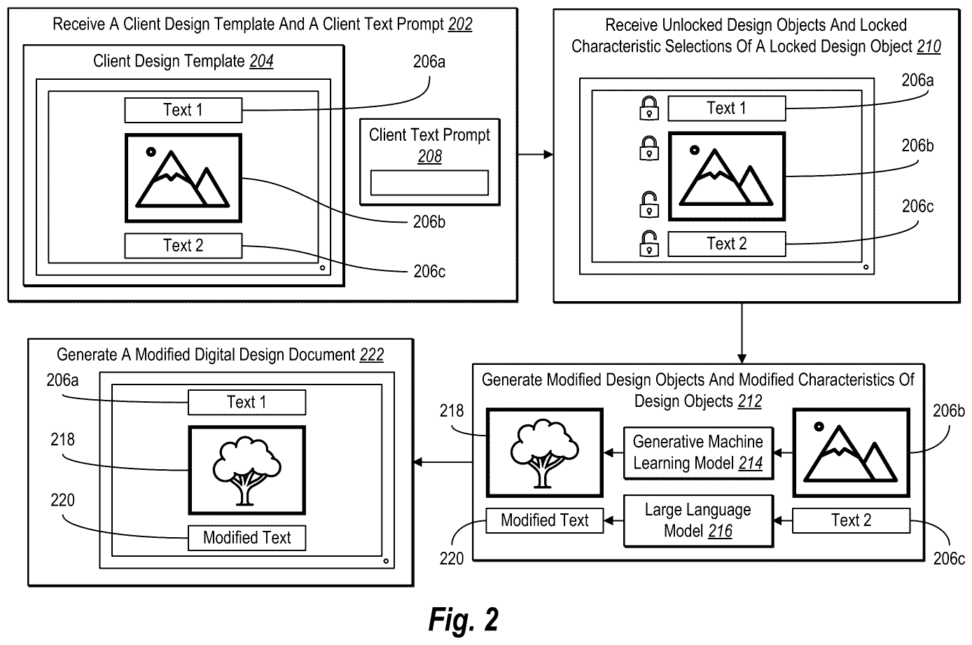

As previously mentioned, in one or more implementations, the custom design object locking system 106 generates digital design documents from client design templates using custom design object locking, large language models, and generative machine learning models. For example, FIG. 2 illustrates an overview diagram of the custom design object locking system 106 generating a modified digital design document from a client design template in accordance with one or more embodiments.

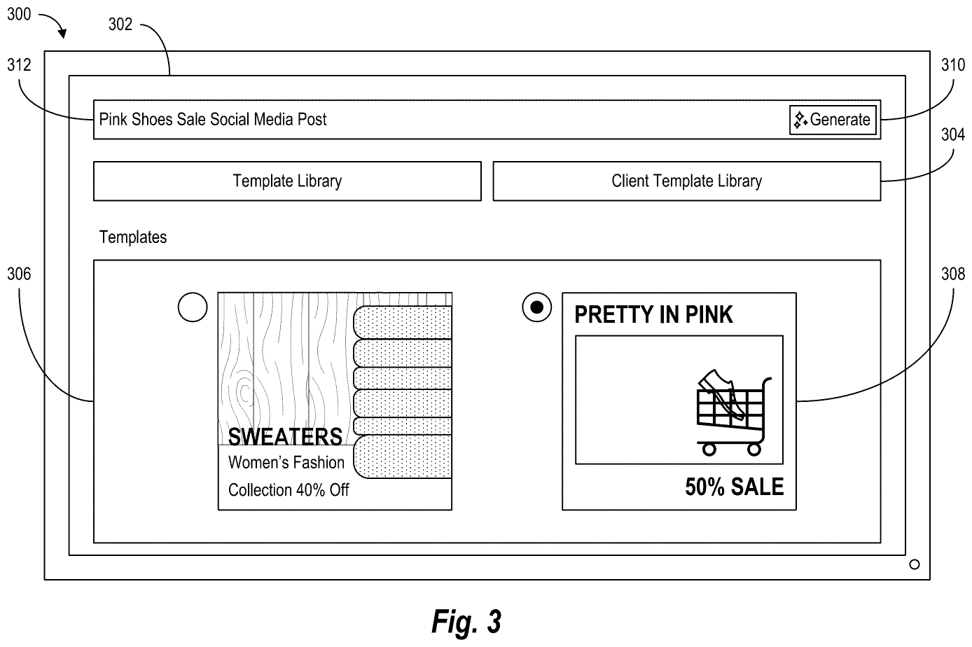

As illustrated in FIG. 2, in some embodiments, the custom design object locking system performs an act 202 of receiving a client design template 204 and a client text prompt 208. Specifically, the custom design object locking system receives the client design template 204 and the client text prompt 208 from a client device via design template generation user interface. In some implementations, the client design template 204 includes various design objects including text objects 206a and 206c as well as digital image 206b. Further, in one or more embodiments, the client text prompt 208 includes text describing a modified digital design document. Additional detail regarding the act 202 of receiving the client design template 204 and the client text prompt 208 is provided with respect to FIG. 3.

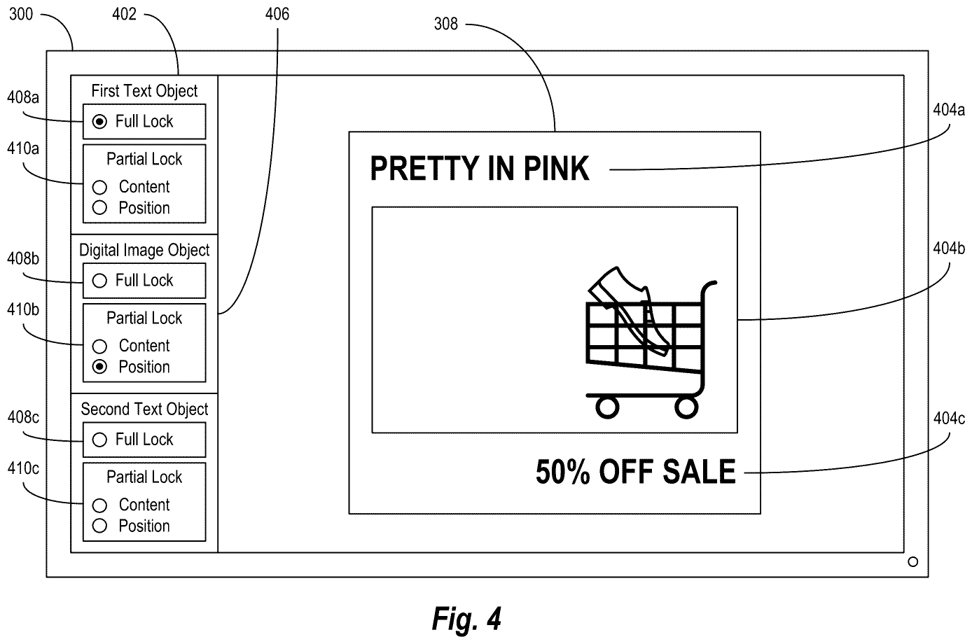

As further illustrated in FIG. 2, in one or more implementations, the custom design object locking system 106 performs an act 210 of receiving unlocked design objects and locked characteristic selections of a locked design object based on receiving lock selections from a client device. For instance, the custom design object locking system 106 receives the unlocked design object, specifically, the text object 206c (e.g., a first design object having a first characteristic that is unlocked) based on the text object 206c not receiving a lock selection and remaining unlocked. Moreover, the custom design object locking system 106 receives a locked characteristic selection of the locked design object, specifically, the digital image 206b (e.g., a second design object). In this example, the digital image 206b is partially locked and the locked characteristic selection locks a position characteristic (e.g., a second characteristic) of the digital image 206b while leaving other characteristics (e.g., a content characteristic) unlocked. Furthermore, in this example, the custom design object locking system 106 receives a lock selection fully locking (i.e., locking all the characteristics of) the text object 206a. Additional detail regarding the act 210 of receiving the unlocked design objects and locked characteristic selections of locked design objects is provided with respect to FIG. 4.

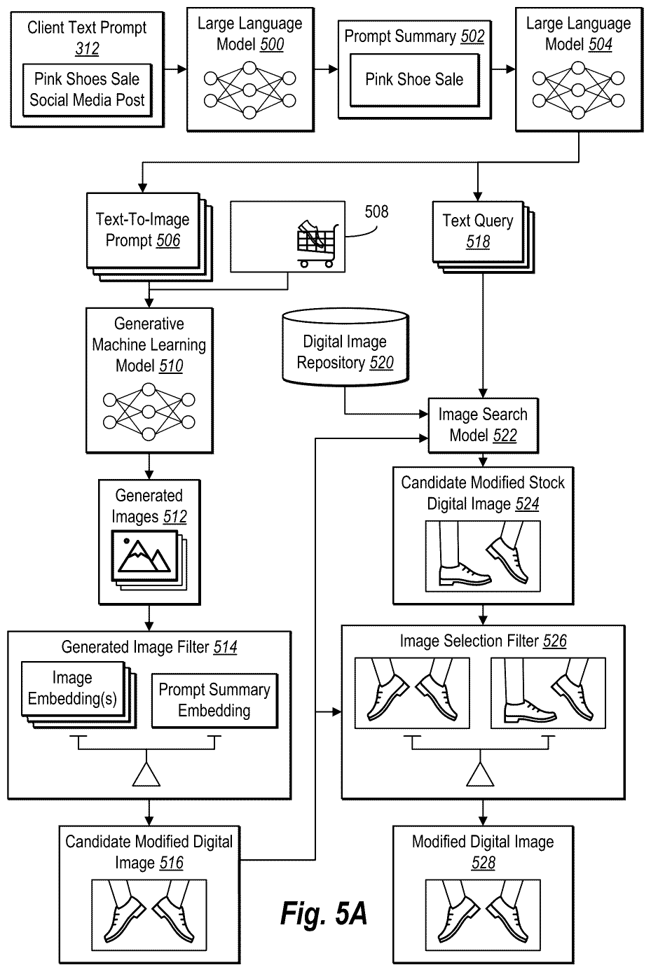

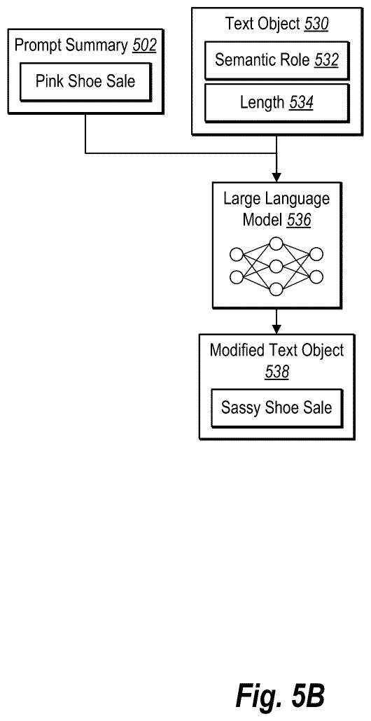

As additionally shown in FIG. 2, in some embodiments, the custom design object locking system 106 performs an act 212 of generating modified design objects and modified characteristics of design objects. Specifically, the custom design object locking system 106 utilizes at least one large language model and a generative machine learning model to generate the modified design objects and characteristics. For example, the custom design object locking system 106 uses the unlocked text object 206c with the large language model 216 to generate a modified design object, i.e., a modified text object 220. Additionally, the custom design object locking system 106 uses the digital image 206b and the generative machine learning model 214 to generate a modified characteristic 218 of the digital image 206b. Specifically, the custom design object locking system 106 generates the modified characteristic 218 by generating a new digital image to replace the content of the digital image 206b. As previously noted, in some implementations, the custom design object locking system 106 generates the modified text object 220 and the modified characteristic 218 based on the client text prompt 208. Additional detail regarding the act 212 of generating modified design objects and modified characteristics of design objects is provided with respect to FIGS. 5A and 5B.

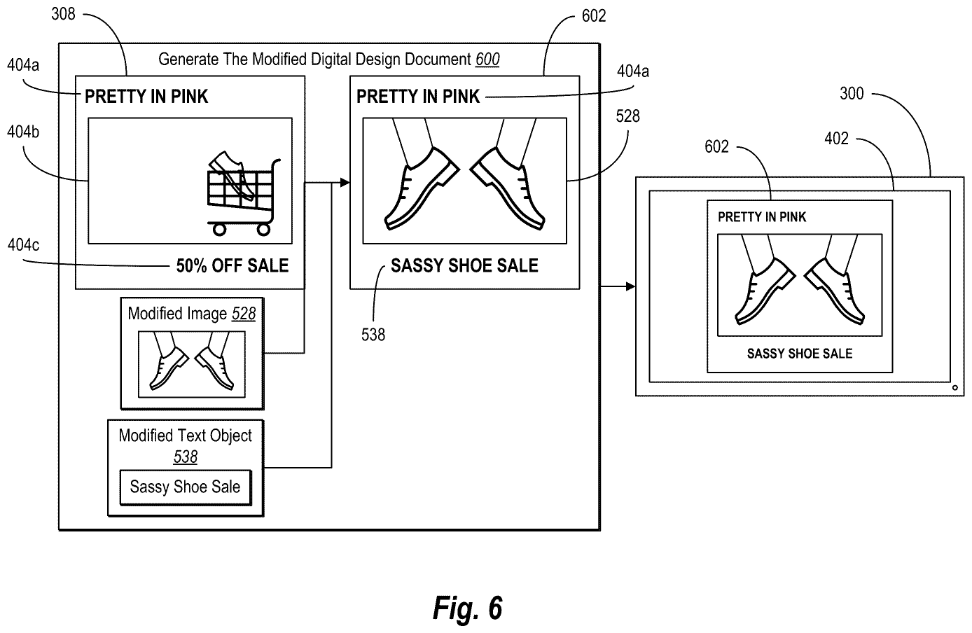

As further illustrated in FIG. 2, in one or more embodiments, the custom design object locking system 106 performs an act 222 of generating a modified digital design document. In particular, the custom design object locking system 106 generates the modified digital design document by replacing unlocked design objects and characteristics of design objects with the modified design objects and modified characteristics of design objects. For instance, the custom design object locking system 106 generates the modified digital design document by replacing the unlocked design object (i.e., the text object 206c) with the modified text object 220. Additionally, the custom design object locking system 106 replaces the unlocked characteristic of the digital image 206b with the modified characteristic 218 while retaining the locked characteristics (e.g., the position) of the digital image 206b. Further, in one or more implementations, the custom design object locking system 106 retains all the characteristics of the fully locked design objects such as text object 206a. Additional detail regarding act 222 of generating a modified digital design document is provided with respect to FIG. 6.

As mentioned above, in some embodiments, the custom design object locking system 106 receives the client design template and the client text prompt from a client device via design template generation user interface. Indeed, FIG. 3 illustrates the custom design object locking system 106 receiving a client design template and client text prompt via an example design template generation user interface in accordance with one or more embodiments.

As shown in FIG. 3, in one or more embodiments, the custom design object locking system 106 generates and provides a design template generation user interface 302 for display via the client device 300. In one or more implementations, the design template generation user interface 302 displays design templates of template libraries. The custom design object locking system 106 uses these design templates for generating digital design documents.

For example, a digital design document includes a digital document including visual information (e.g., visual content such as digital text or digital images). In some embodiments, a digital design document includes design objects which include designs, images, text, shapes, layouts, color schemes, typography, etc. for conveying information to an audience. In various embodiments, digital design documents range from static designs for posters, flyers, social media posts, etc. to dynamic social media posts, web ads, banners, web elements, etc. intended for online placement. Examples of digital design documents include digital flyers or posters designed for events, social media posts optimized for specific dimensions and audience engagement on various social media platforms, etc.

Relatedly, a client design template includes a digital design template for creating a digital design document. Specifically, similar to a digital design document, a client design template includes design objects which include digital image objects, text objects, chart objects, shapes, layers, layouts, color schemes, typography, etc. for conveying the information to an audience. Moreover, in some implementations, a client design template includes brand-specific elements of a client such as logos, color palettes, fonts, images, etc. both in digital design template itself as well as the design objects included therein. In some cases, a client design template includes pre-structured layouts (or layout portions) intended to remain the same across different digital design documents or layouts (or layout portions) intended to change during creation of digital design documents. For example, in one or more embodiments, a client design template includes a logo with characteristics such as content and location that are intended to remain the same, or text objects with brand information such as a brand name intended to remain the same, while the location is flexible, etc.

As noted above, in one or more implementations, the design template generation user interface 302 displays design templates of template libraries. For example, the design template generation user interface 302 displays a template library including generic design templates and/or a client template library including client design templates. Specifically, the client template library includes pre-made client design templates such as from previous advertising campaigns, events, social media posts, etc. As illustrated in FIG. 3, when a client template library element 304 of the design template generation user interface 302 is selected, the custom design object locking system 106 displays the client design templates of the client template library.

As also depicted in FIG. 3, in some embodiments, the custom design object locking system 106 generates and provides the design template generation user interface 302 to include a client design template selection element 306. For example, when the client template library element 304 is selected, the custom design object locking system 106 displays the client design template selection element 306 for selection of one or more of the client design templates of the client template library. Furthermore, in some implementations, the custom design object locking system 106 identifies a client design template 308 from which to generate a digital design document based on user interaction with the client design template selection element 306. To illustrate, based on a user interaction with the client design template selection element 306 selecting the client design template 308, the custom design object locking system 106 identifies the client design template 308 for further processing to generate a modified digital design document from the client design template 308.

As further illustrated in FIG. 3, in one or more embodiments, the custom design object locking system 106 generates and provides the design template generation user interface 302 to include a prompt input element 310. In one or more implementations, the custom design object locking system 106 receives a client text prompt 312 from the client device 300 via the prompt input element 310. For example, the custom design object locking system 106 receives the client text prompt 312 describing a modified digital design template. In these or other embodiments, the custom design object locking system 106 generates the modified digital design document from the client design template 308 based on the client text prompt 312.

In some embodiments, the custom design object locking system 106 receives a client text prompt including written input or instructions for generating digital content (e.g., provided by a client device to guide generative AI systems for content creation). Specifically, a client text prompt includes text input received by the custom design object locking system 106 to guide the custom design object locking system 106 in generating a modified digital design document from a client design template. For instance, a client text prompt might include a request like “generate an illustration of a futuristic city for a science fair poster” or “write a short story about a detective solving a mystery in space for a social media post.”

To illustrate, the custom design object locking system 106 receives a client text prompt 312 including the text “Pink shoes sale social media post” via the prompt input element 310. Based on this description from the client text prompt 312 the custom design object locking system 106 generates a modified digital design document from the client design template 308 for a social media post about a pink shoe sale according to the client's brand elements, as described in further detail below.

As mentioned previously, in some implementations, the custom design object locking system 106 receives unlocked design objects and selections of locked characteristics of locked design objects of the client design template. Indeed, in one or more embodiments, the custom design object locking system 106 receives the unlocked design objects and selections of locked characteristics of locked design objects from the client device. FIG. 4 illustrates a diagram of the custom design object locking system 106 receiving lock selections of design objects of a client design template in accordance with one or more embodiments.

As portrayed in FIG. 4, in one or more implementations, the custom design object locking system 106 generates and provides a lock selection user interface 402 for display at the client device 300. In some embodiments, the custom design object locking system 106 displays a selected client design template 308 via the lock selection user interface 402. Additionally, in some implementations, the custom design object locking system 106 receives lock selections of design objects of the client design template 308 via the lock selection user interface 402.

In one or more embodiments, a design object conveys information and/or includes design elements of a client design template. Specifically, a design object includes digital objects that include content such as text, images, etc. for displaying information and designs to an audience. For example, design objects include digital image objects, text objects, shapes, designs, backgrounds, borders, shading, effects, buttons, etc. In one or more implementations, design objects include characteristics which include the various properties that define the design objects. For instance, a design object includes characteristics such as content, position, size, shape, color, opacity, depth, padding, alignment, a background or background image, etc.

As noted previously, the custom design object locking system 106 receives lock selections of design objects 404a-c of the client design template 308. For example, the custom design object locking system 106 receives lock selections for the design objects 404a-c of the client design template 308 including a first text object 404a, a digital image object 404b (e.g., a second design object), and a second text object 404c (e.g., a first design object).

In some embodiments, a text object includes a block or element that contains written content as digital text. For example, a text object includes text content such as titles, headlines, body text, captions, etc. In some implementations, the custom design object locking system 106 is capable of styling the text object content with fonts, sizes, colors, layouts, etc. Further, in one or more embodiments, the custom design object locking system 106 is capable of modifying characteristics of text objects such as by generating new content of the text object, resizing the content of the text object, resizing or modifying the shape of the text object, etc. Additionally, in one or more implementations, a digital image object includes a visual element containing a graphic, photo, illustration, or other visual content. In some embodiments, the custom design object locking system 106 is capable of modifying characteristics of the digital image object as described further below. For example, the custom design object locking system 106 generates new content of the digital image object, crops the content of the digital image object, resizes or reshapes the digital image objects, etc.

As additionally shown in FIG. 4, in some implementations, the custom design object locking system 106 generates and provides the lock selection user interface 402 to include a lock selection pane 406. In one or more embodiments, the custom design object locking system 106 displays lock selection elements within the lock selection pane 406 for receiving the lock selections of the design objects. In particular, the lock selection pane includes full lock selection elements 408a-c for locking a plurality of characteristics (e.g., all characteristics) of a locked design object and/or partial lock selection elements 410a-c for locking one or more characteristics of the locked design object while leaving other characteristics unlocked. In one or more implementations, the custom design object locking system 106 displays a full lock selection element and a partial lock selection element for each design object of the client design template 308.

To illustrate, as shown in FIG. 4, the custom design object locking system 106 receives a selection of locked characteristics of the first text object 404a via the full lock selection element 408a rather than via the partial lock selection element 410a. Specifically, based on the selection of the full lock selection element 408a, the custom design object locking system 106 determines that a plurality of characteristics of the first text object 404a are locked. In some embodiments, the custom design object locking system 106 determines that all the characteristics of the first text object 404a are locked based on the selection of the full lock selection element 408a. Moreover, in some implementations, the custom design object locking system 106 retains the locked characteristics of the first text object 404a when generating a modified digital design document from the client design template 308 as discussed further with respect to FIG. 6.

To further illustrate, the custom design object locking system 106 receives a selection of locked characteristics of the digital image object 404b via the partial lock selection element 410b rather than via the full lock selection element 408b. In particular, as shown in FIG. 4, the custom design object locking system 106 receives selections of specific locked characteristics via the partial lock selection elements 410a-c. For instance, the custom design object locking system 106 receives a selection of a locked position characteristic (e.g., a second characteristic) of the digital image object 404b (e.g., the second design object) via the partial lock selection element 410b. Based on this selection, the custom design object locking system 106 determines that the position of the digital image object 404b within the client design template 308 is locked, but identifies other characteristics (e.g., the content or digital image, etc.) of the digital image object 404b that are unlocked. Based on identifying unlocked characteristics of the digital image object 404b, the custom design object locking system 106 generates modified characteristics (e.g., a modified digital image) as discussed further with respect to FIGS. 5A and 5B.

Furthermore, in one or more embodiments, the custom design object locking system 106 identifies and receives unlocked design objects of the client design template 308. Specifically, the custom design object locking system 106 identifies unlocked design objects based on not receiving selections of locked characteristics of a design object. For example, if the custom design object locking system 106 determines that neither the full lock selection element nor the partial lock selection element include a selection of one or more locked characteristics, the custom design object locking system 106 identifies that the design object is unlocked.

To illustrate, the custom design object locking system 106 identifies and receives the unlocked second text object 404c (e.g., a first design object). Specifically, the custom design object locking system 106 determines that neither the full lock selection element 408c nor the partial lock selection element 410c includes selections of locked characteristics. Based on this lack of selections of locked characteristics, the custom design object locking system 106 receives the unlocked second text object 404c to generate a modified design object (e.g., a modified text object). Indeed, the custom design object locking system 106 determines that the characteristics, such as a content characteristic (e.g., a first characteristic) of the unlocked second text object 404c are unlocked characteristics. For instance, the custom design object locking system 106 generates a modified text object from the unlocked second text object 404c as further described in FIG. 5B.

Additionally, in one or more implementations, the custom design object locking system 106 identifies and receives unlocked chart objects or characteristics of chart objects of the client design template 308. Specifically, a chart object includes an object or element with a visual depiction of data or datasets. For example, a chart object includes visual data representations such as line graphs, bar graphs, pie charts, histograms, scatter plots, area charts, etc. Similar to the text objects 404a and 404c and the digital image object 404b, described above, the custom design object locking system 106 determines unlocked chart objects and/or characteristics of chart objects based on receiving selections of full lock selection elements or partial lock selection elements. Further, in some embodiments, the custom design object locking system 106 generates modified chart objects similar to other design objects as discussed in further detail below.

As previously mentioned, in some implementations, the custom design object locking system 106 generates modified design objects and modified characteristics of design objects. Indeed, in one or more embodiments, the custom design object locking system 106 generates the modified design objects and characteristics for inclusion in a modified digital design document. FIGS. 5A and 5B illustrate diagrams of the custom design object locking system generating modified design objects or modified characteristics of design objects in accordance with one or more embodiments. In one or more implementations, to generate a modified design object or a modified characteristic of a design object, the custom design object locking system 106 generates a modified digital image. FIG. 5A illustrates a diagram of the custom design object locking system 106 generating a modified digital image for inclusion in a modified digital design document in accordance with one or more embodiments.

As depicted in FIG. 5A, in some embodiments, the custom design object locking system 106 generates a modified design object (or a modified characteristic of a design object) based on the client text prompt 312. Specifically, the custom design object locking system 106 uses the client text prompt 312 with a large language model 500 to generate a prompt summary 502. For example, the custom design object locking system 106 uses a large language model which includes a machine learning model trained to generate language/text outputs. In particular, a large language model includes a machine learning model that utilizes a transformer architecture to identify patterns, relationships and context within text. In one or more implementations, the custom design object locking system 106 utilizes one or more large language models to generate prompt summaries, design objects, or design object characteristics in response to one or more inputs (e.g., a client text prompt and/or information extracted from a digital design document). In particular, the large language model includes a neural network with parameters trained on large quantities of data (e.g., unlabeled text) using a particular learning technique (e.g., self-supervised learning). For example, a large language model includes parameters trained to generate or identify prompt summaries, design objects, or design object characteristics based on various contextual data (e.g., the client text prompt 312).

In some implementations, the custom design object locking system 106 generates the prompt summary 502 to include a concise overview or restatement of the input (e.g., the client text prompt 312). For example, the custom design object locking system 106 generates an input prompt with the client text prompt 312 that includes instructions to generate a summary from the client text prompt 312. For instance, the input prompt can include a text instruction that includes desired parameters of the summary (e.g., length, measure of detail), examples (e.g., example inputs and summaries), and the client text prompt 312. Thus, the custom design object locking system 106 generates the prompt summary 502 to include the key aspects or intent of the client text prompt 312 while removing extraneous details or non-essential information. To illustrate, the custom design object locking system 106 generates the prompt summary 502 to include the text “pink shoe sale” from the client text prompt 312 including text “pink shoes sale social media post.”

As further illustrated in FIG. 5A, in one or more embodiments, the custom design object locking system 106 uses the prompt summary 502 to generate pairs of text-to-image prompts 506 and text queries 518. In particular, the custom design object locking system 106 uses the prompt summary 502 as an input (e.g., as part of an additional input prompt with additional instructions, parameters, and examples of text-to-image prompts and/or text queries) to a large language model 504 to generate the text-to-image prompt 506/text query 518 pairs. For example, the custom design object locking system 106 generates the text-to-image prompts 506 with the large language model 504 to include varying text-to-image prompts for prompting a generative machine learning model to generate varying images related to the prompt summary. In one or more implementations, the custom design object locking system 106 uses the large language model 500 rather than a separate large language model 504 to generate the text-to-image prompt 506/text query 518 pairs.

In some embodiments, the custom design object locking system 106 uses the large language model 504 to generate text-to-image prompts including written input that directs an artificial intelligence system to generate an image. Specifically, the text-to-image prompts direct artificial intelligence systems to generate images based on the text content of the text-to-image prompts. Moreover, in some implementations, the custom design object locking system 106 generates the text-to-image prompts to include descriptive language detailing objects, scenes, styles, emotions, etc.

As also depicted in FIG. 5A, in one or more embodiments, the custom design object locking system 106 uses a generative machine learning model to produce generated images 512. Specifically, the custom design object locking system 106 uses the text-to-image prompts 506 and the original digital image 508 of the digital image object 404b of the client design template 308 as input to the generative machine learning model 510 to generate the generated images 512. In these or other embodiments, the custom design object locking system 106 generates the generated images 512 as part of generating a modified characteristic from an unlocked characteristic of a design object (e.g., the content, or the digital image, of the digital image object 404b). Similarly, if the digital image object 404b were fully unlocked, the custom design object locking system 106 uses the same process to generate a modified design object from the original design object (i.e., the digital image object 404b).

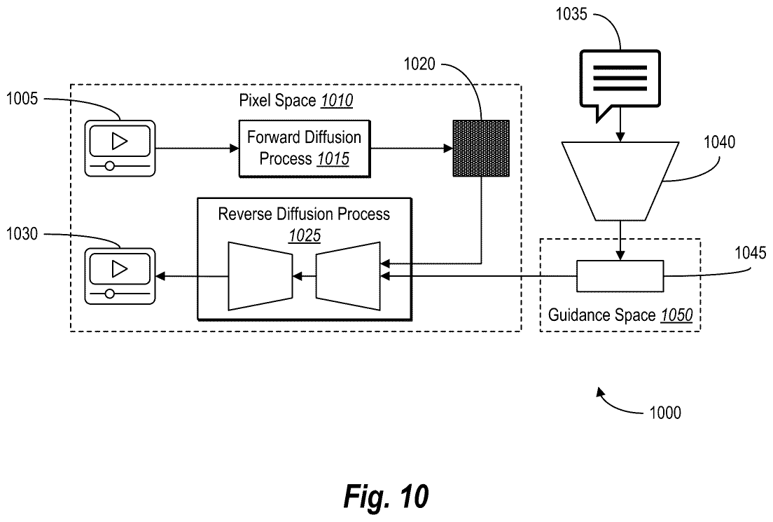

As mentioned, the custom design object locking system 106 uses a generative machine learning model 510 to generate the generated images 512. For example, the custom design object locking system 106 uses a generative machine learning model that includes a generative machine learning model, such as a generative adversarial neural network or a diffusion model, that generates digital images (e.g., from a text input). For example, the generative machine learning model can include Adobe Firefly. Additional detail regarding a generative machine learning model (including a diffusion network architecture) is provided below in relation to FIGS. 10-17.

As further illustrated in FIG. 5A, in one or more implementations, the custom design object locking system 106 selects a candidate modified digital image 516 using a generated image filter 514. In particular, the custom design object locking system 106 uses the generated image filter 514 to select the candidate modified digital image 516 from among the generated images 512. For instance, the custom design object locking system 106 uses a similarity measure (e.g., a cosine similarity) between embeddings of the generated images 512 (also referred to herein as “generated image embeddings”) and a prompt summary embedding. In these or other embodiments, the custom design object locking system 106 utilizes an embedding model to generate the image embeddings from the generated images 512 and the prompt summary embedding from the prompt summary 502. For example, the custom design object locking system 106 generates these embeddings and performs the similarity measure using a machine learning model designed to understand and relate text and images in the same embedding space (e.g., AdobeOne). Based on the similarity measure, the custom design object locking system 106 selects one of the generated images 512 (e.g., one with the highest similarity to the prompt summary 502) as the candidate modified digital image 516.

As additionally shown in FIG. 5A, in some embodiments, the custom design object locking system 106 selects an additional candidate modified digital image (e.g., a candidate modified stock digital image 524) to select the modified digital image 528. Specifically, the custom design object locking system 106 selects the candidate modified stock digital image 524 from a repository of digital images (i.e., a digital image repository 520). For example, the custom design object locking system 106 uses the text queries 518 and the generated candidate modified digital image 516 as inputs to an image search model 522 to select the candidate modified stock digital image 524.

In some implementations, the custom design object locking system 106 generates the text queries 518 (e.g., using the large language model 504) to include text input used to search for relevant content within a database (e.g., the digital image repository 520). Specifically, a text query provides keywords, phrases, and/or descriptions of content (e.g., digital images) that a search model uses to identify and retrieve relevant content matching the keywords, phrases, and/or descriptions. For example, a text query includes text such as “blue sky with clouds,” “vintage cars,” or “modern architecture at night” to prompt the search model to return one or more digital images that fit those descriptions.

In one or more embodiments, the custom design object locking system 106 uses an image search model including a system or model designed to retrieve images from a database that match a given search query (e.g., the text queries 518). In particular, an image search model analyzes input data, such as text queries and/or reference images (e.g., the candidate modified digital image 516), and compares them to features within the image database to identify relevant results. For instance, an image search model returns images of a blue sky with clouds when given a descriptive text query or find visually similar images when provided with a reference image of a specific object or scene. In one or more implementations, the custom design object locking system 106 utilizes an embedding model (as described above) to generate embeddings of the search query and digital images in a repository of digital images. The custom design object locking system 106 can compare the search query embedding and the digital image embeddings to identify one or more matching digital images.

As further illustrated in FIG. 5A, in one or more implementations, the custom design object locking system 106 generates the modified digital image 528 using an image selection filter 526. For instance, the custom design object locking system 106 uses the image selection filter 526 to compare the candidate modified digital image 516 and the candidate modified stock digital image 524. In particular, the custom design object locking system 106 generates embeddings for each of the candidate modified digital image 516 and the candidate modified stock digital image 524. Furthermore, in some embodiments, the custom design object locking system 106 compares (e.g., with a similarity measure such as a cosine similarity) the embeddings for the candidate modified digital image 516 and the candidate modified stock digital image 524 with the prompt summary embedding to select the modified digital image 528. Indeed, in some implementations, the custom design object locking system 106 selects the modified digital image 528 based on which candidate digital image has the highest similarity with the prompt summary 502.

In one or more embodiments, by generating the modified digital image 528, the custom design object locking system 106 generates a modified characteristic (e.g., a content characteristic) for replacement of an unlocked characteristic of a design object. In some instances, by generating the modified digital image 528, the custom design object locking system 106 generates the modified design object for replacement of an unlocked design object.

As previously noted, in one or more implementations, the custom design object locking system 106 generates modified design objects and modified characteristics of design objects for inclusion in a modified digital design document. As also mentioned, in some cases, to generate a modified design object or a modified characteristic of a design object, the custom design object locking system 106 generates a modified text object. FIG. 5B illustrates a diagram of the custom design object locking system 106 generating a modified text object for inclusion in a modified digital design document in accordance with one or more embodiments.

As illustrated in FIG. 5B, in some embodiments, the custom design object locking system 106 generates a modified text object 538. Specifically, the custom design object locking system 106 uses a large language model 536 to generate the modified text object 538 based on the prompt summary 502 and the text object 530. For example, the custom design object locking system 106 uses the prompt summary 502 and features of the text object 530 as inputs to a large language model 536 (e.g., as part of an input prompt that includes instructions, parameters, and examples for generating a text object from a prompt summary).

In some implementations, the custom design object locking system 106 uses one or more parameters of the text object 530 to generate the modified text object 538 using the large language model 536. Specifically, the custom design object locking system 106 uses a semantic role parameter 532 and/or a length parameter 534 of the text object 530 as inputs with the prompt summary 502 to the large language model 536. In one or more embodiments, the semantic role parameter 532 provides context regarding the role of the text object 530 (e.g., title, call to action, location, time, date, etc.) within the client design template. For example, the custom design object locking system 106 extracts or determines a semantic role from the text object 530 (e.g., utilizing a classification model or a natural language model to determine the semantic role of the text object). Additionally, in one or more implementations, the length parameter 534 of the text object 530 provides an estimated length (e.g., number of words) for the modified text object 538 as guidance to the large language model 536. The custom design object locking system 106 can extract or determine the length parameter 534 from the text object 530. In some embodiments, the custom design object locking system 106 disregards the original content (e.g., the text) of the text object 530 when generating the modified text object 538 (e.g., analyzes the semantic role parameter 532 and the length parameter 534 without the actual text content of the text object 530).

Further, in some implementations, the custom design object locking system 106 generates a modified chart object based on input received via the prompt input element. Specifically, the custom design object locking system 106 generates the modified chart object and/or modified characteristics of the chart object based on data or datasets received via the prompt input element. For example, in one or more embodiments, the custom design object locking system 106 receives data or datasets through the prompt input element or other user interface interaction at the client device. To illustrate, the custom design object locking system 106 receives data via a data document (e.g., a CSV file).

Moreover, in one or more implementations, the custom design object locking system 106 generates the modified chart object based on updated data. Specifically, the custom design object locking system 106 determines that data in the data document is updated relative to a previous data document or relative to the data included in the chart object of the client design template. For unlocked chart objects or unlocked characteristics, the custom design object locking system 106 generates an updated chart object including the updated data of the data document received via the prompt input element.

To illustrate, in some embodiments, the custom design object locking system 106 determines that a chart object displaying a bar graph is unlocked. In this example, the bar graph of the chart object includes four bars and is the content characteristic of the chart object. Further, in this example, the custom design object locking system 106 also determines, based on the data document, that the data used to generate two bars of the bar graph is updated relative to the previous data document used to generate the bar graph of the chart object. Based on determining that the data for the two bars is updated, the custom design object locking system 106 generates a modified bar graph to reflect the updated data of the data document. Additionally, in this example, the custom design object locking system 106 determines that the updated bars of the modified bar graph exceed the bounds of the chart object of the client design template and therefore generates a modified chart object (e.g., by modifying the size characteristic of the chart object) that is large enough to accommodate the updated bars of the modified bar chart.

In some embodiments, the custom design object locking system 106 provides locking input to the generative machine learning model 510 and the large language model 536 as part of generating modified design objects and characteristics of design objects. For example, based on the lock selections (e.g., as described with respect to FIG. 4), the custom design object locking system 106 provides the locking input (e.g., via instructions for generating digital content included with a query or prompt) regarding which characteristics of a design object are locked and which are unlocked. In these or other embodiments, based on this locking input, the generative machine learning model 510 and/or the large language model 536 generate modified design objects and characteristics of design objects as described above.

As described above with respect to FIGS. 5A and 5B, in some implementations, the custom design object locking system 106 generates the modified design objects and modified characteristics of the design objects as described with respect to the design generation pipeline and the document generation results from various prompts in U.S. application Ser. No. 18/903,274, filed Oct. 1, 1724, entitled DESIGN DOCUMENT GENERATION FROM TEXT, the contents of which are herein incorporated by reference in their entirety.

As mentioned above, in one or more embodiments, the custom design object locking system 106 generates a modified digital design document from the client design template. Indeed, in one or more implementations, the custom design object locking system 106 generates the modified digital design document by replacing unlocked design objects and unlocked characteristics of design objects with modified design objects and modified characteristics of design objects. FIG. 6 illustrates a diagram of the custom design object locking system 106 generating and displaying a modified digital design document in accordance with one or more embodiments.

As shown in FIG. 6, in some embodiments, the custom design object locking system 106 performs an act 600 of generating a modified digital design document 602. Specifically, the custom design object locking system 106 generates the modified digital design document 602 from the client design template 308. For example, the custom design object locking system 106 generates the modified digital design document 602 by replacing the unlocked design objects and unlocked characteristics of the design objects of the client design template 308 with modified design objects and modified characteristics of design objects. Furthermore, in some implementations, the custom design object locking system 106 retains locked design objects and locked characteristics of design objects of the client design template 308 in the modified digital design document 602.

To illustrate, the custom design object locking system 106 retains the locked first text object 404a of the client design template 308 when generating the modified digital design document 602. As discussed above, the custom design object locking system 106 receives a selection of the full lock selection element 408a and determines that a plurality of the characteristics of the first text object 404a are locked. In this example, the custom design object locking system 106 determines that all the characteristics of the first text object 404a are locked and therefore all the characteristics are retained. For example, the custom design object locking system 106 retains the content characteristic (e.g., the text “pretty in pink”), the position characteristic (e.g., the upper left-hand corner), etc. of the first text object 404a when generating the modified digital design document 602 to include the first text object 404a.

To illustrate further, the custom design object locking system 106 replaces the unlocked characteristic (i.e., the content) of the locked digital image object 404b when generating the modified digital design document 602. As explained above, the custom design object locking system 106 receives a selection of the partial lock selection element 410b and determines that the position characteristic of the digital image object 404b is locked but that other characteristics (e.g., the content characteristic) of the digital image object 404b are unlocked. In response, the custom design object locking system 106 generates a modified characteristic (i.e., the modified digital image 528) to replace the unlocked content characteristic of the digital image object 404b. In this example, the custom design object locking system 106 replaces the unlocked content characteristic of the digital image object 404b of the client design template 308 with the modified digital image 528 when generating the modified digital design document 602. Additionally, in this example, the custom design object locking system 106 retains the locked position characteristic of the digital image object 404b by generating the modified digital design document 602 to include the modified digital image 528 in the same position (i.e., centered). In one or more embodiments, the custom design object locking system 106 also modifies other unlocked characteristics of the digital image object 404b such as size, shape, opacity, depth, etc.

To further illustrate, the custom design object locking system 106 replaces the unlocked second text object 404c. For example, as discussed above, the custom design object locking system 106 does not receive a selection of either the full lock selection element 408c or the partial lock selection element 410c and determines that the second text object 404c of the client design template 308 is unlocked. In response, the custom design object locking system 106 generates the modified text object 538 to replace the unlocked second text object 404c. Indeed, in one or more implementations, because the second text object 404c is unlocked the custom design object locking system 106 generates a modified text object 538 with potentially an entirely new set of characteristics. In this example, the custom design object locking system 106 generates the modified digital design document 602 by replacing the unlocked second text object 404c of the client design template 308 with the modified text object 538. Accordingly, as shown in FIG. 6, the custom design object locking system 106 generates the modified digital design document 602 to include the modified text object with a new content characteristic (e.g., the text “sassy shoe sale”), a new position characteristic (e.g., centered at the bottom of the modified digital design document 602), etc.

In some embodiments, the custom design object locking system 106 generates a modified text object or content characteristic of a text object which cannot be accommodated within the modified digital design document 602, such as due to a locked size characteristic of the text object or because of size restrictions resulting from the size of the modified digital design document 602 itself. In these embodiments, the custom design object locking system 106 further modifies the modified text object or modified characteristic to ensure a fit within the modified digital design document 602. For example, in some implementations, the custom design object locking system 106 further modifies the modified text object or modified characteristic by reducing a font size of the text or wrapping the text onto a second line, etc. Similarly, in the case of a modified image that does not fit within the designated location/position, the custom design object locking system 106 resizes or crops the modified image to ensure a fit within the modified digital design document 602 while retaining adequate visibility, resolution, and relevant content.

To illustrate further, the custom design object locking system 106 replaces an unlocked chart object with a modified chart object. For example, as described above with respect to FIGS. 5A and 5B, the custom design object locking system 106 generates a modified chart object by generating a modified bar chart (i.e., the content characteristic) and modifying the size characteristic of the chart object to accommodate the modified bar chart. In this example, the custom design object locking system 106 replaces the chart object of the client design template with the modified chart object when generating the modified digital design document. Further, in some implementations, the custom design object locking system 106 generates modified text objects to accompany the chart object. For example, the custom design object locking system 106 generates modified text objects (e.g., that function as labels for the chart object) based on the updated data of the data document.

As also depicted in FIG. 6, in one or more embodiments, upon generating the modified digital design document 602 form the client design template 308, the custom design object locking system 106 provides the modified digital design document 602 for display. Specifically, the custom design object locking system 106 provides the modified digital design document 602 for display via the design template generation user interface 302 at the client device 300.

In one or more implementations, the custom design object locking system 106 generates multiple modified digital design documents from multiple client design templates at once. For example, in some embodiments, each of the client design templates of the client template library include lock selections for the various design objects contained within the client design templates. In these or other embodiments, upon receiving the client text prompt via the prompt input element, the custom design object locking system 106 selects a plurality of client design templates (e.g., four) from the client template library and generates a modified digital design document for each of the selected client design templates.

In some cases, the client template library contains more client design templates than the number selected for generation of modified digital design documents. In these or other embodiments, the custom design object locking system 106 generates a digital image (e.g., a raster image) of each client design template in the library. Further, the custom design object locking system 106 generates an embedding for each of the images of the client design templates for comparison with an embedding of the client text prompt or the prompt summary (e.g., using a machine learning model designed to understand and relate text and images in the same embedding space). Based on a similarity measure (e.g., a cosine similarity) between these embeddings, the custom design object locking system 106 selects the client design templates with the highest similarity (e.g., the top four client design templates) to the client text prompt or the prompt summary. The custom design object locking system 106 uses these selected client design templates to generate digital design documents.

Turning to FIG. 7, additional detail will now be provided regarding various components and capabilities of the custom design object locking system. In particular, FIG. 7 illustrates an example schematic diagram of a computing device 700 (e.g., the server device(s) 102 and/or the client device(s) 110) implementing the custom design object locking system in accordance with one or more embodiments of the present disclosure for components 700-708. As illustrated in FIG. 7, the custom design object locking system includes a user interface manager 702, a design object generator 704, a digital design document generator 706, and data storage 708.

The user interface manager 702 receives design templates, client text prompts, unlocked design objects, and unlocked characteristics of design objects. For example, the user interface manager 702 receives a selected client design template from a client template library via a client device. Specifically, the custom design object locking system 106 receives the client design template via a design template generation user interface displayed on the client device. Additionally, the user interface manager 702 receives a client text prompt describing a modified digital design document via a prompt input element of the design template generation user interface. Furthermore, in some implementations, the user interface manager 702 receives unlocked design objects and unlocked characteristics of design objects from the client design templates based on a selection of a locked characteristic of a locked design object. For example, the user interface manager 702 receives the unlocked design objects and unlocked characteristics of design objects via a lock selection user interface. Moreover, the user interface manager 702 interacts with other components to pass the client design templates, client text prompts, unlocked design objects, and unlocked characteristics of design objects for further processing.

The design object generator 704 generates modified design objects and modified characteristics of design objects. For example, the design object generator 704 receives the client text prompts, unlocked design objects, and unlocked characteristics of design objects from the user interface manager 702. Further, the design object generator 704 generates the modified design objects and modified characteristics of the design objects using one large language model(s) 114 based on the client text prompt and the unlocked design objects and unlocked characteristics of design objects. In one or more embodiments, the design object generator 704 generates the modified design objects and modified characteristics of the design objects using the generative machine learning model 510. Furthermore, the design object generator 704 passes the modified design objects and modified characteristics of the design objects for further processing.

The digital design document generator 706 generates a modified digital design document. For example, the digital design document generator 706 receives the client design templates, the modified design objects, and the modified characteristics of the design objects. Additionally, the digital design document generator 706 generator replaces the unlocked design objects and unlocked characteristics of design objects in the client design templates. Specifically, the digital design document generator 706 replaces the unlocked design objects and unlocked characteristics of design objects with the modified design objects and the modified characteristics of the design objects. Further, the digital design document generator 706 retains locked design objects and locked characteristics of design objects from the client design templates in the modified digital design document.

The data storage 708 stores design templates, design objects, datasets, modified design objects, digital design documents, and embeddings. For example, the data storage 708 stores design templates and design objects, and receives datasets (e.g., as part of a prompt). Moreover, the data storage 708 stores generated modified design objects, digital design document, and embeddings utilized by the custom design object locking system 106.

Each of the components 702-708 of the custom design object locking system can include software, hardware, or both. For example, the components 702-708 can include one or more instructions stored on a computer-readable storage medium and executable by processors of one or more computing devices, such as a client device or server device. When executed by the one or more processors, the computer-executable instructions of the custom design object locking system cause the computing device(s) to perform the methods described herein. Alternatively, the components 702-708 include hardware, such as a special-purpose processing device to perform a certain function or group of functions. Alternatively, the components 702-708 of the custom design object locking system include a combination of computer-executable instructions and hardware.

Furthermore, the components 702-708 of the custom design object locking system are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 702-708 of the custom design object locking system are implemented as a stand-alone application, such as a desktop or mobile application. Furthermore, in various embodiments, the components 702-708 of the custom design object locking system are implemented as one or more web-based applications hosted on a remote server. Alternatively, or additionally, the components 702-708 of the custom design object locking system are implemented in a suite of mobile device applications or “apps.” For example, in one or more embodiments, the custom design object locking system comprises or operates in connection with digital software applications such as ADOBE® EXPRESS®.

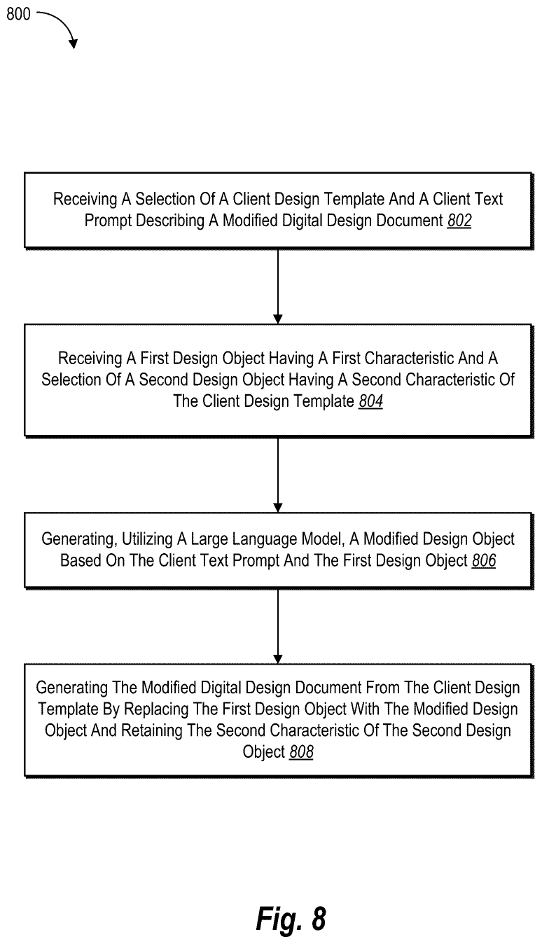

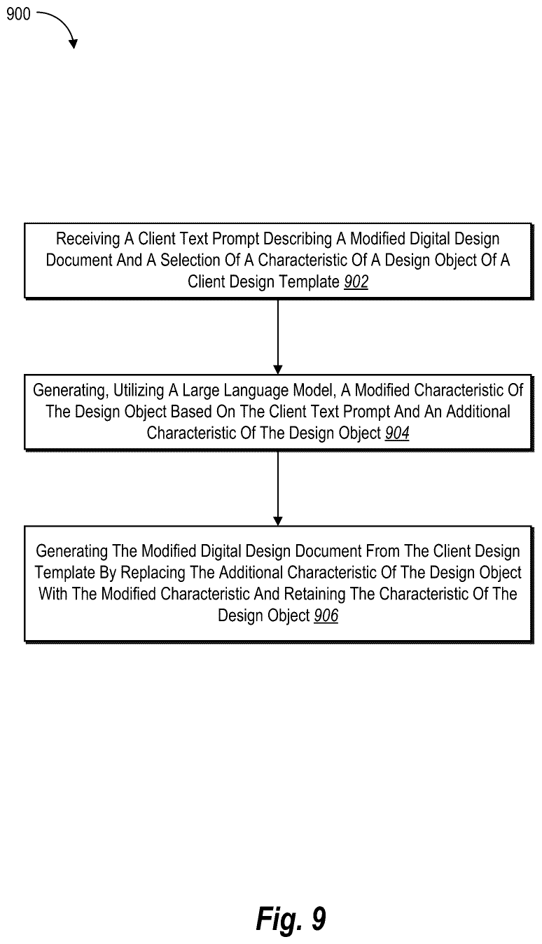

FIGS. 1-7, the corresponding text, and the examples provide a number of different systems, methods, and non-transitory computer readable media for generating digital design documents from client design templates using custom design object locking, large language models, and generative machine learning models. In addition to the foregoing, embodiments can also be described in terms of flowcharts comprising acts for accomplishing a particular result. For example, FIGS. 8-9 illustrate flowcharts of example sequences of acts in accordance with one or more embodiments.

While FIGS. 8-9 illustrate acts according to some embodiments, alternative embodiments may omit, add to, reorder, and/or modify any of the acts shown in FIGS. 8-9. The acts of FIGS. 8-9 can be performed as part of a method. Alternatively, a non-transitory computer readable medium can comprise instructions, that when executed by one or more processors, cause a computing device to perform the acts of FIGS. 8-9. In still further embodiments, a system can perform the acts of FIGS. 8-9. Additionally, the acts described herein may be repeated or performed in parallel with one another or in parallel with different instances of the same or other similar acts.

FIG. 8 illustrates an example series of acts 800 for generating a modified digital design document by replacing an unlocked design object of a client design template with a modified design object in accordance with one or more embodiments. The series of acts 800 can include an act 802 of receiving a selection of a client design template and a client text prompt describing a modified digital design document; an act 804 of receiving a first design object having a first characteristic and a selection of a second design object having a second characteristic of the client design template; an act 806 of generating, utilizing a large language model, a modified design object based on the client text prompt and the first design object; and an act 808 of generating the modified digital design document from the client design template by replacing the first design object with the modified design object and retaining the second characteristic of the second design object.

In some embodiments, the act 802 includes receiving, from a client device, a selection of a client design template from a client template library and a client text prompt describing a modified digital design document. In some embodiments, the act 804 also includes an act of receiving, from the client device, an unlocked design object and a selection of a locked characteristic of a locked design object from a plurality of design objects of the client design template. In some implementations, the act 806 further includes an act of generating, utilizing a large language model, a modified design object based on the client text prompt and the unlocked design object. Additionally, in one or more embodiments, the act 808 includes an act of generating, by at least one processing device, the modified digital design document from the client design template by replacing the unlocked design object with the modified design object and retaining the locked characteristic of the locked design object.

In some implementations, receiving the selection of the locked characteristic includes receiving selection of a full lock selection element for locking a plurality of characteristics of the locked design object. In one or more implementations, the series of acts 800 also includes an act of generating the modified digital design document includes retaining the plurality of characteristics of the locked design object.

In one or more embodiments, receiving the selection of the locked characteristic includes receiving selection of a partial lock selection element for locking the locked characteristic of the locked design object.

In one or more implementations, the series of acts 800 includes identifying an unlocked characteristic of the locked design object. In some embodiments, the series of acts 800 further includes an act of generating, utilizing the large language model, a modified characteristic of the locked design object from the unlocked characteristic.

In some embodiments, generating the modified digital design document from the client design template further includes replacing the unlocked characteristic of the locked design object with the modified characteristic while retaining the locked characteristic of the locked design object.

In some implementations, generating the modified design object includes generating, using the large language model, at least one of a modified digital image, or a modified text object.

In one or more embodiments, generating the modified text object includes generating, using the large language model, a prompt summary from the client text prompt. Additionally, in some implementations, the series of acts 800 includes an act of generating, using the large language model, the modified text object based on the prompt summary and a length parameter of an original text object of the client design template.

In one or more implementations, generating the modified digital image includes generating, using the large language model, a prompt summary from the client text prompt. In one or more embodiments, the series of acts 800 also includes an act of generating, using a generative machine learning model, a candidate modified digital image based on the prompt summary and an original digital image of the client design template.

In some embodiments, generating the modified digital image includes selecting, using an image search model, an additional candidate modified digital image from a repository of digital images based on the prompt summary and the candidate modified digital image. In one or more implementations, the series of acts 800 further includes an act of comparing an embedding of the candidate modified digital image, an embedding of the additional candidate modified digital image, and an embedding of the prompt summary to select the modified digital image.

In one or more implementations, the series of acts 800 includes receiving, from a client device, a selection of a client design template from a client template library and a client text prompt describing a modified digital design document. Additionally, in some embodiments, the series of acts 800 includes an act of receiving, from the client device, an unlocked design object and a selection of a locked characteristic of a locked design object from a plurality of design objects of the client design template. In some implementations, the series of acts 800 also includes an act of generating, utilizing a large language model, a modified design object based on the client text prompt and the unlocked design object. In one or more embodiments, the series of acts 800 further includes an act of generating, by at least one processing device, the modified digital design document from the client design template by replacing the unlocked design object with the modified design object and retaining the locked characteristic of the locked design object.

In some embodiments, receiving the selection of the locked characteristic includes receiving selection of at least one of a full lock selection element for locking a plurality of characteristics of the locked design object or a partial lock selection element for locking the locked characteristic of the locked design object.

In some implementations, generating the modified digital design document includes retaining, in response to receiving the full lock selection element, the plurality of characteristics of the locked design object.

In one or more embodiments, the series of acts 800 includes generating, in response to receiving the partial lock selection element and utilizing the large language model, a modified characteristic of the locked design object from at least one unlocked characteristic of the locked design object.

In one or more implementations, generating the modified characteristic includes generating a modified text object by generating, using the large language model, a prompt summary from the client text prompt. Additionally, in one or more implementations, the series of acts 800 includes an act of generating, using the large language model, the modified text object based on the prompt summary, a length parameter of an original text object of the client design template, and a semantic role parameter of the original text object.

FIG. 9 illustrates an example series of acts 900 for generating a modified digital design document by replacing an unlocked characteristic of a design object in a client design template with a modified characteristic in accordance with one or more embodiments. The series of acts 900 can include an act 902 of receiving a client text prompt describing a modified digital design document and a selection of a characteristic of a design object of a client design template; an act 904 of generating, utilizing a large language model, a modified characteristic of the design object based on the client text prompt and an additional characteristic of the design object; and an act 906 of generating the modified digital design document from the client design template by replacing the additional characteristic of the design object with the modified characteristic and retaining the characteristic of the design object.

In some implementations, the act 902 includes receiving from a client device a client text prompt describing a modified digital design document and a selection of a locked characteristic of a design object of a client design template. In some embodiments, the act 904 also includes an act of generating, utilizing a large language model, a modified characteristic of the design object based on the client text prompt and an unlocked characteristic of the design object. In some implementations, the act 906 further includes an act of generating the modified digital design document from the client design template by replacing the unlocked characteristic of the design object with the modified characteristic and retaining the locked characteristic of the design object.

In some implementations, the series of acts 900 includes providing, for display via the client device, a design template generation user interface including a prompt input element and a client design template selection element. Additionally, in one or more embodiments, the series of acts 900 includes an act of identifying the client design template and the client text prompt based on user interaction with the prompt input element and the client design template selection element. In one or more implementations, the series of acts 900 also includes an act of upon generating the modified digital design document from the client design template, providing the modified digital design document for display via the design template generation user interface.

In one or more embodiments, generating, utilizing the large language model, the modified characteristic of the design object based on the client text prompt and the unlocked characteristic of the design object includes generating, utilizing the large language model, a prompt summary from the client text prompt. In some embodiments, the series of acts 900 further includes an act of generating, utilizing one or more large language models, a text-to-image prompt from the prompt summary. Additionally, in some implementations, the series of acts 900 includes an act of generating, using a generative machine learning model, a candidate modified characteristic by generating a candidate modified digital image from the text-to-image prompt and an original digital image of the client design template.

In one or more implementations, the series of acts 900 includes generating, utilizing at least one large language model, a text query from the prompt summary. In one or more embodiments, the series of acts 900 also includes an act of selecting, using an image search model, an additional candidate modified digital image from a repository of digital images based on the text query and the candidate modified digital image.

In some embodiments, the series of acts 900 includes comparing an embedding of the candidate modified digital image, an embedding of the additional candidate modified digital image, and an embedding of the prompt summary to select the modified characteristic.

In some implementations, the series of acts 900 includes generating, utilizing the large language model, the modified characteristic by generating a modified text object from a semantic role parameter of the design object and a length parameter of the design object.

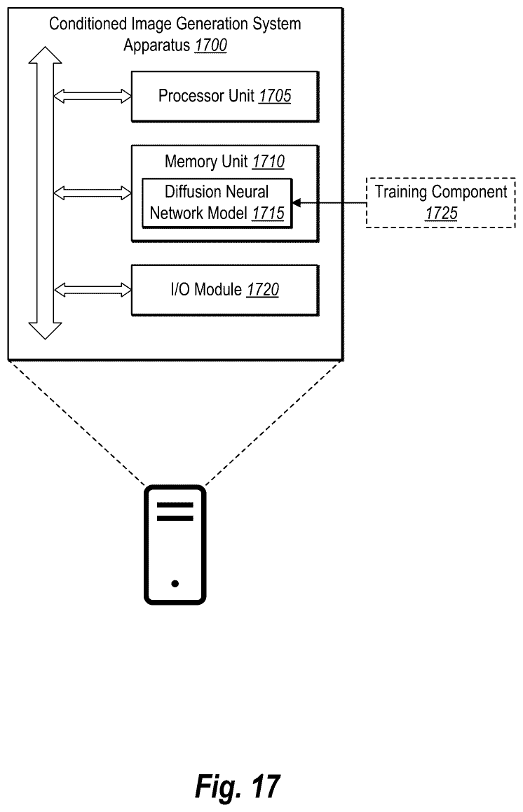

FIG. 10 shows an example of a guided diffusion model 1000 according to aspects of the present disclosure. In some examples, guided diffusion model 1000 describes the operation and architecture of the diffusion neural network model 1715 described with reference to FIG. 17. The guided diffusion model 1000 depicted in FIG. 10 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 1000 may take an original media item 1005 in a pixel space 1010 as input and apply forward diffusion process 1015 to gradually add noise to the original media item 1005 to obtain noisy media item 1020 at various noise levels.

Next, a reverse diffusion process 1025 (e.g., a U-Net) gradually removes the noise from the noisy media item 1020 at the various noise levels to obtain an output media item 1030. In some cases, an output media item 1030 is created from each of the various noise levels. The output media item 1030 can be compared to the original media item 1005 to train the reverse diffusion process 1025.

The reverse diffusion process 1025 can also be guided based on a text prompt 1035, or another guidance prompt, such as an image, a layout, a segmentation map, etc. The text prompt 1035 can be encoded using a text encoder 1040 (e.g., a multimodal encoder) to obtain guidance features 1045 in guidance space 1050. The guidance features 1045 can be combined with the noisy media item 1020 at one or more layers of the reverse diffusion process 1025 to ensure that the output media item 1030 includes content described by the text prompt 1035. For example, guidance features 1045 can be combined with the noisy features using a cross-attention block within the reverse diffusion process 1025.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

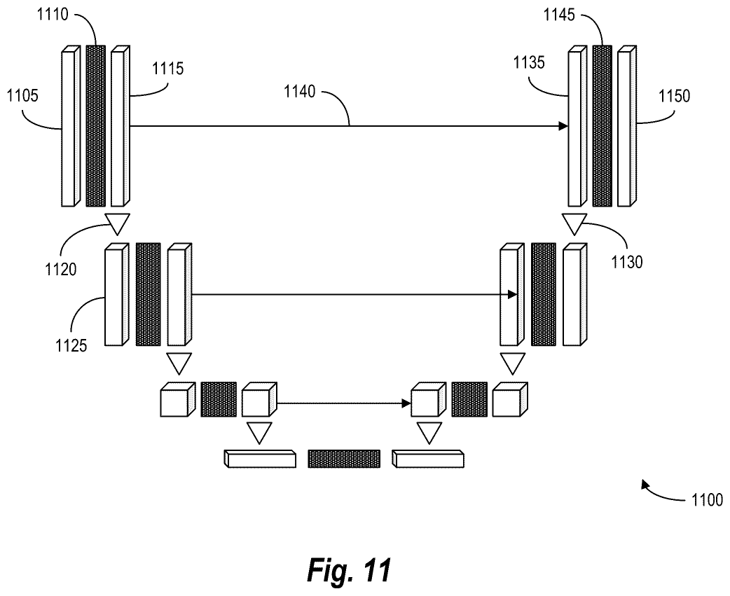

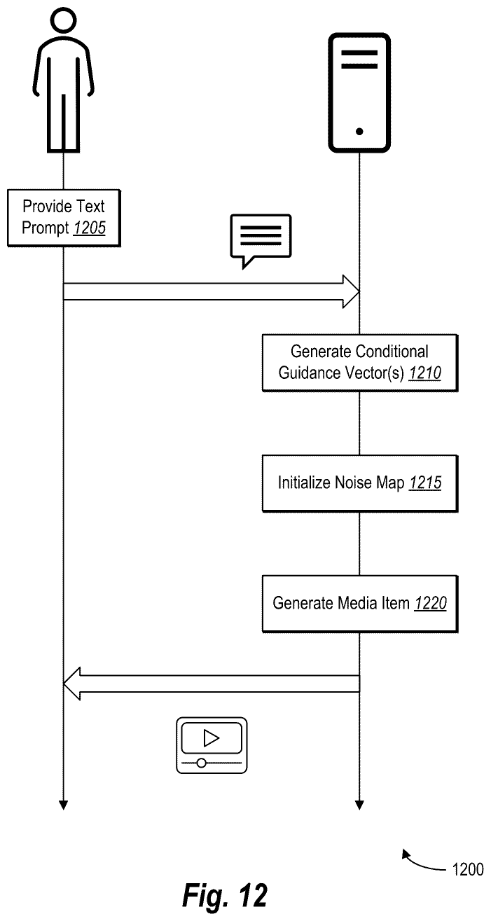

FIG. 11 shows an example of a U-Net 1100 according to aspects of the present disclosure. In some examples, U-Net 1100 is an example of the component that performs the reverse diffusion process 1025 of guided diffusion model 1000 described with reference to FIG. 10 and includes architectural elements of the diffusion neural network model 1715 described with reference to FIG. 17. The U-Net 1100 depicted in FIG. 11 is an example of, or includes aspects of, the architecture used within the reverse diffusion process described with reference to FIG. 12.

In some examples, diffusion models are based on a neural network architecture known as a U-Net. The U-Net 1100 takes input features 1105 having an initial resolution and an initial number of channels and processes the input features 1105 using an initial neural network layer 1110 (e.g., a convolutional network layer) to produce intermediate features 1115. The intermediate features 1115 are then down-sampled using a down-sampling layer 1120 such that down-sampled features 1125 features have a resolution less than the initial resolution and a number of channels greater than the initial number of channels.

This process is repeated multiple times, and then the process is reversed. That is, the down-sampled features 1125 are up-sampled using up-sampling process 1130 to obtain up-sampled features 1135. The up-sampled features 1135 can be combined with intermediate features 1115 having the same resolution and number of channels via a skip connection 1140. These inputs are processed using a final neural network layer 1145 to produce output features 1150. In some cases, the output features 1150 have the same resolution as the initial resolution and the same number of channels as the initial number of channels.

In some cases, U-Net 1100 takes additional input features to produce conditionally generated output. For example, the additional input features could include a vector representation of an input prompt. The additional input features can be combined with the intermediate features 1115 within the neural network at one or more layers. For example, a cross-attention module can be used to combine the additional input features and the intermediate features 1115.

FIG. 12 shows an example of a method 1200 for conditional media generation according to aspects of the present disclosure. In some examples, method 1200 describes an operation of the diffusion neural network model 1715 described with reference to FIG. 17 such as an application of the guided diffusion model 1000 described with reference to FIG. 10. In some examples, these operations are performed by a system including a processor executing a set of codes to control functional elements of an apparatus such as the media generation model described in FIG. 10.

Additionally or alternatively, steps of the method 1200 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1205, a user provides a text prompt describing content to be included in a generated media item. For example, a user may provide the prompt “a person playing with a cat”. In some examples, guidance can be provided in a form other than text, such as via an image, a sketch, or a layout.

At operation 1210, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1215, a noise map is initialized that includes random noise. The noise map may be in a pixel space or a latent space. By initializing a media item with random noise, different variations of a media item including the content described by the conditional guidance can be generated.

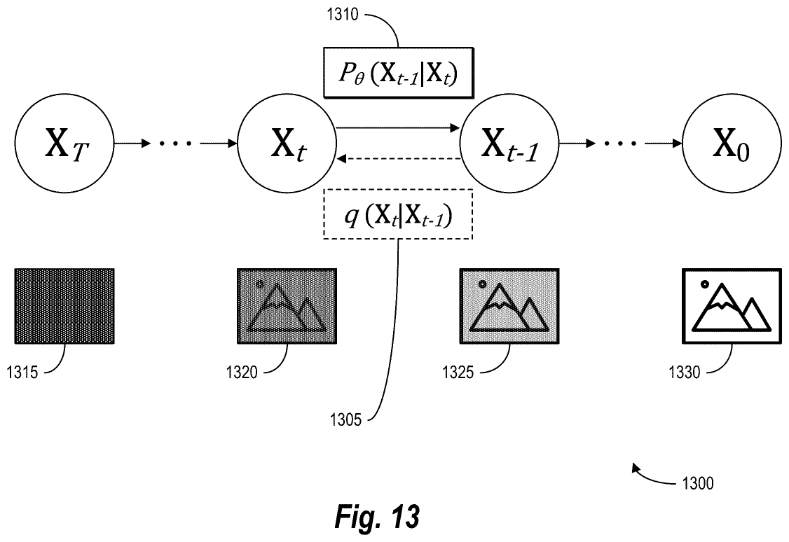

At operation 1220, the system generates a media item based on the noise map and the conditional guidance vector. For example, the media item may be generated using a reverse diffusion process as described with reference to FIG. 13.

FIG. 13 shows a diffusion process 1300 according to aspects of the present disclosure. In some examples, diffusion process 1300 describes an operation of the diffusion neural network model 1715 described with reference to FIG. 17, such as the reverse diffusion process 1025 of guided diffusion model 1000 described with reference to FIG. 10.

As described above with reference to FIG. 10, using a diffusion model can involve both a forward diffusion process 1305 for adding noise to a media item (or features in a latent space) and a reverse diffusion process 1310 for denoising the media item (or features) to obtain a denoised media item. The forward diffusion process 1305 can be represented as q(xₜ|xₜ₋₁), and the reverse diffusion process 1310 can be represented as p(xₜ₋₁|xₜ). In some cases, the forward diffusion process 1305 is used during training to generate media items with successively greater noise, and a neural network is trained to perform the reverse diffusion process 1310 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1310, the model begins with noisy data x_{T}, such as a noisy media item 1315 and denoises the data to obtain the p(xₜ₋₁|xₜ). At each step t−1, the reverse diffusion process 1310 takes xₜ, such as first intermediate media item 1320, and t as input. Here, t represents a step in the sequence of transitions associated with different noise levels, The reverse diffusion process 1310 outputs xₜ₋₁, such as second intermediate media item 1325 iteratively until x_{T} reverts back to x₀, the original media item 1330. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

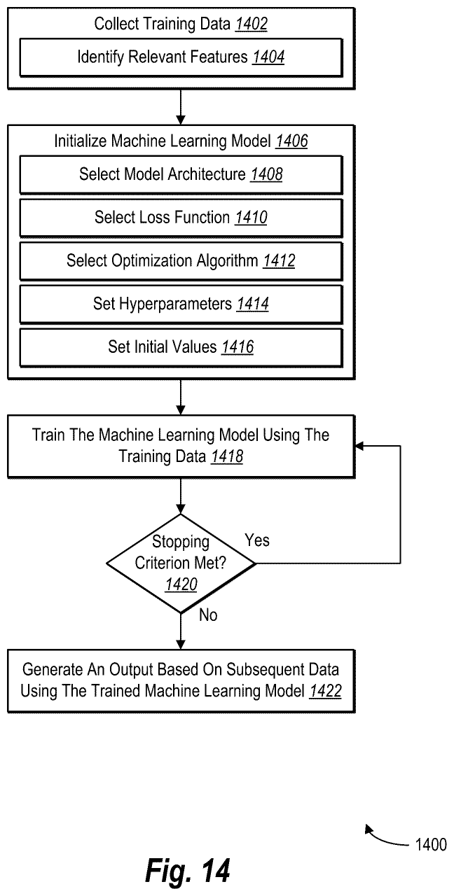

FIG. 14 is a flow diagram depicting an algorithm as a step-by-step procedure 1400 in an example implementation of operations performable for training a machine-learning model. In some embodiments, the procedure 1400 describes an operation of the training component 1725 described for configuring the diffusion neural network model 1715 as described with reference to FIG. 17. The procedure 1400 provides one or more examples of generating training data, use of the training data to train a machine-learning model, and use of the trained machine-learning model to perform a task.

To begin in this example, a machine-learning system collects training data (block 1402) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1406). Initialization of the machine-learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1410). The loss function is utilized to measure a difference between an output of the machine-learning model (i.e., predictions) and target values (e.g., as expressed by the training data) to be used to train the machine-learning model. Additionally, an optimization algorithm is selected (1412) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1416) examples of which includes initializing weights and biases of nodes to improve efficiency in training and computational resources consumption as part of training. Hyperparameters are also set (block 1414) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1420), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), the procedure 1400 continues training of the machine-learning model using the training data (block 1418) in this example.

If the stopping criterion is met (“yes” from decision block 1420), the trained machine-learning model is then utilized to generate an output based on subsequent data (block 1422). The trained machine-learning model, for instance, is trained to perform a task as described above and therefore once trained is configured to perform that task based on subsequent data received as an input and processed by the machine-learning model.

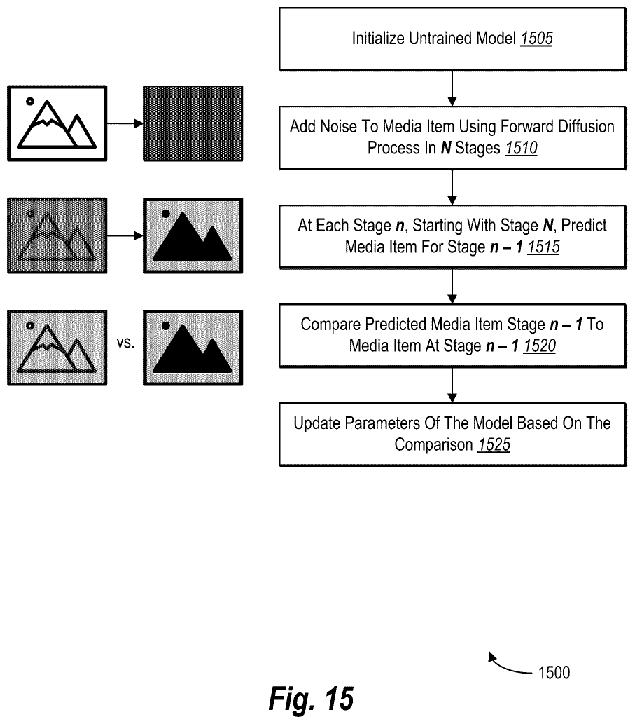

FIG. 15 shows an example of a method 1500 for training a diffusion model according to aspects of the present disclosure. In some embodiments, the method 1500 describes an operation of the training component 1725 described for configuring the diffusion neural network model 1715 as described with reference to FIG. 17. The method 1500 represents an example for training a reverse diffusion process as described above with reference to FIG. 13. In some examples, these operations are performed by a system including a processor executing a set of codes to control functional elements of an apparatus, such as the guided diffusion model described in FIG. 10.

Additionally or alternatively, certain processes of method 1500 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1505, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1510, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1515, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1525, the system updates parameters of the model based on the comparison. For example, parameters of a U-Net may be updated using gradient descent. Time-dependent parameters of the Gaussian transitions can also be learned.

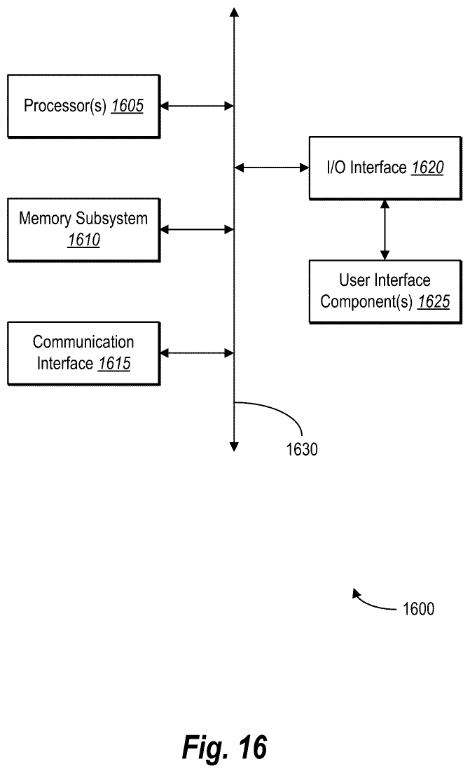

FIG. 16 shows an example of a computing device 1600 according to aspects of the present disclosure. The computing device 1600 may be an example of the conditioned image generation system apparatus 1700 described with reference to FIG. 17. In one aspect, computing device 1600 includes processor(s) 1605, memory subsystem 1610, communication interface 1615, I/O interface 1620, user interface component(s) 1625, and channel 1630.

In some embodiments, computing device 1600 is an example of, or includes aspects of, the media generation model of FIG. 10. In some embodiments, computing device 1600 includes one or more processors 1605 that can execute instructions stored in memory subsystem 1610 to perform media generation.

According to some aspects, computing device 1600 includes one or more processors 1605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or via hardware components controlled by the I/O controller.

According to some aspects, user interface component(s) 1625 enable a user to interact with computing device 1600. In some cases, user interface component(s) 1625 include an audio device, such as an external speaker system, an external display device such as a display screen, an input device (e.g., a remote-control device interfaced with a user interface directly or through the I/O controller), or a combination thereof. In some cases, user interface component(s) 1625 include a GUI.

FIG. 17 shows an example of an conditioned image generation system apparatus 1700 according to aspects of the present disclosure. Conditioned image generation system apparatus 1700 may include an example of, or aspects of, the guided diffusion model described with reference to FIG. 10 and the U-Net described with reference to FIG. 11. In some embodiments, conditioned image generation system apparatus 1700 includes processor unit 1705, memory unit 1710, diffusion neural network model 1715, I/O module 1720, and training component 1725. Training component 1725 updates parameters of the diffusion neural network model 1715 stored in memory unit 1710. In some examples, the training component 1725 is located outside the conditioned image generation system apparatus 1700.

Processor unit 1705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1705 is configured to operate a memory array using a memory controller. In other cases, a memory controller is integrated into processor unit 1705. In some cases, processor unit 1705 is configured to execute computer-readable instructions stored in memory unit 1710 to perform various functions. In some aspects, processor unit 1705 includes special purpose components for modem processing, baseband processing, digital signal processing, or transmission processing. According to some aspects, processor unit 1705 comprises one or more processors described with reference to FIG. 16.

Memory unit 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1705 to perform various functions described herein.

In some cases, memory unit 1710 includes a basic input/output system (BIOS) that controls basic hardware or software operations, such as an interaction with peripheral components or devices. In some cases, memory unit 1710 includes a memory controller that operates memory cells of memory unit 1710. For example, the memory controller may include a row decoder, column decoder, or both. In some cases, memory cells within memory unit 1710 store information in the form of a logical state. According to some aspects, memory unit 1710 is an example of the memory subsystem 1610 described with reference to FIG. 16.

According to some aspects, conditioned image generation system apparatus 1700 uses one or more processors of processor unit 1705 to execute instructions stored in memory unit 1710 to perform functions described herein. For example, the conditioned image generation system apparatus 1700 may generate synthesized digital images based on a color conditioning input and an image prompt.

The memory unit 1710 may include a diffusion neural network model 1715 trained to generate synthesized digital images based on a color conditioning input and an image prompt. For example, after training, the diffusion neural network model 1715 may perform inferencing operations as described with reference to FIGS. 12 and 13 to generate synthesized digital images based on a color conditioning input and an image prompt.

In some embodiments, the diffusion neural network model 1715 is an Artificial neural network (ANN) such as the guided diffusion model described with reference to FIG. 10 and the U-Net described with reference to FIG. 11. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion neural network model 1715 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1725 may train the diffusion neural network model 1715. For example, parameters of the diffusion neural network model 1715 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 14 and 15). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion neural network model 1715 can be used to make predictions on new, unseen data (i.e., during inference).

I/O module 1720 receives inputs from and transmits outputs of the conditioned image generation system apparatus 1700 to other devices or users. For example, I/O module 1720 receives inputs for the diffusion neural network model 1715 and transmits outputs of the diffusion neural network model 1715. According to some aspects, I/O module 1720 is an example of the I/O interface 1620 described with reference to FIG. 16.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, a selection of a client design template from a client template library and a client text prompt describing a modified digital design document;
receiving, from the client device, a first design object having a first characteristic and a selection of a second design object having a second characteristic from a plurality of design objects of the client design template;
generating, utilizing a large language model, a modified design object based on the client text prompt and the first design object, wherein the modified design object has a modified characteristic different than the first characteristic; and
generating, by at least one processing device, the modified digital design document from the client design template by replacing the first design object with the modified design object and retaining the second characteristic of the second design object.

2. The method of claim 1, wherein:
receiving the selection of the second characteristic comprises receiving selection of a full lock selection element for locking a plurality of characteristics of the second design object; and
generating the modified digital design document comprises retaining the plurality of characteristics of the second design object.

3. The method of claim 1, wherein receiving the selection of the second characteristic comprises receiving selection of a partial lock selection element for locking the second characteristic of the second design object.

4. The method of claim 3, further comprising:
identifying an unlocked characteristic of the second design object; and
generating, utilizing the large language model, a modified characteristic of the second design object from the unlocked characteristic.

5. The method of claim 4, wherein generating the modified digital design document from the client design template further comprises replacing the unlocked characteristic of the second design object with the modified characteristic while retaining the second characteristic of the second design object.

6. The method of claim 1, wherein generating the modified design object comprises generating, using the large language model, at least one of a modified digital image, or a modified text object.

7. The method of claim 6, wherein generating the modified text object comprises:
generating, using the large language model, a prompt summary from the client text prompt; and
generating, using the large language model, the modified text object based on the prompt summary and a length parameter of an original text object of the client design template.

8. The method of claim 6, wherein generating the modified digital image comprises:
generating, using the large language model, a prompt summary from the client text prompt; and
generating, using a generative machine learning model, a candidate modified digital image based on the prompt summary and an original digital image of the client design template.

9. The method of claim 8, wherein generating the modified digital image comprises:
selecting, using an image search model, an additional candidate modified digital image from a repository of digital images based on the prompt summary and the candidate modified digital image; and
comparing an embedding of the candidate modified digital image, an embedding of the additional candidate modified digital image, and an embedding of the prompt summary to select the modified digital image.

10. A system comprising:
a memory component; and
one or more processing devices coupled to the memory component, the one or more processing devices to perform operations comprising:
receiving from a client device:
a client text prompt describing a modified digital design document; and
a selection of a characteristic of a design object of a client design template;
generating, utilizing a large language model, a modified characteristic of the design object based on the client text prompt and an additional characteristic of the design object; and
generating the modified digital design document from the client design template by replacing the additional characteristic of the design object with the modified characteristic and retaining the characteristic of the design object.

11. The system of claim 10, wherein the operations further comprise:
providing, for display via the client device, a design template generation user interface comprising a prompt input element and a client design template selection element;
identifying the client design template and the client text prompt based on user interaction with the prompt input element and the client design template selection element; and
upon generating the modified digital design document from the client design template, providing the modified digital design document for display via the design template generation user interface.

12. The system of claim 10, wherein generating, utilizing the large language model, the modified characteristic of the design object based on the client text prompt and the additional characteristic of the design object comprises:
generating, utilizing the large language model, a prompt summary from the client text prompt;
generating, utilizing one or more large language models, a text-to-image prompt from the prompt summary; and
generating, using a generative machine learning model, a candidate modified characteristic by generating a candidate modified digital image from the text-to-image prompt and an original digital image of the client design template.

13. The system of claim 12, wherein the operations further comprise:
generating, utilizing at least one large language model, a text query from the prompt summary; and selecting, using an image search model, an additional candidate modified digital image from a repository of digital images based on the text query and the candidate modified digital image.

14. The system of claim 13, wherein the operations further comprise comparing an embedding of the candidate modified digital image, an embedding of the additional candidate modified digital image, and an embedding of the prompt summary to select the modified characteristic.

15. The system of claim 10, wherein the operations further comprise:
generating, utilizing the large language model, the modified characteristic by generating a modified text object from a semantic role parameter of the design object and a length parameter of the design object.

16. A non-transitory computer readable medium storing executable instructions which, when executed by a processing device, cause the processing device to perform operations comprising:
receiving, from a client device, a selection of a client design template from a client template library and a client text prompt describing a modified digital design document;
receiving, from the client device, a first design object having a first characteristic and a selection of a second design object having a second characteristic from a plurality of design objects of the client design template;
generating, utilizing a large language model, a modified design object based on the client text prompt and the first design object, wherein the modified design object has a modified characteristic different than the first characteristic; and
generating, by at least one processing device, the modified digital design document from the client design template by replacing the first design object with the modified design object and retaining the second characteristic of the second design object.

17. The non-transitory computer readable medium of claim 16, wherein receiving the selection of the second characteristic comprises receiving selection of at least one of a full lock selection element for locking a plurality of characteristics of the second design object or a partial lock selection element for locking the second characteristic of the second design object.

18. The non-transitory computer readable medium of claim 17, wherein generating the modified digital design document comprises retaining, in response to receiving the full lock selection element, the plurality of characteristics of the second design object.

19. The non-transitory computer readable medium of claim 17, wherein the operations further comprise generating, in response to receiving the partial lock selection element and utilizing the large language model, a modified characteristic of the second design object from at least one unlocked characteristic of the second design object.

20. The non-transitory computer readable medium of claim 19, wherein generating the modified characteristic comprises generating a modified text object by:
generating, using the large language model, a prompt summary from the client text prompt; and
generating, using the large language model, the modified text object based on the prompt summary, a length parameter of an original text object of the client design template, and a semantic role parameter of the original text object.
